(19) United States
(12) Patent Application Publication
(10) Pub. No.: US 2015/0023017 A1
(43) Pub. Date: Jan. 22, 2015

(54) LIGHT TOWER

(71) Applicant: RIDE Inc., Alberta (CA)

(72) Inventors: Paul S. Smith, Drayton Valley (CA); Danny S. Smith, Drayton Valley (CA); Gregory A. Hartman, Drayton Valley (CA)

(73) Assignee: RIDE Inc., Alberta (CA)

(21) Appl. No.: 13/945,742

(22) Filed: Jul. 18, 2013

(51) Int. Cl. F21V 21/22

(52) U.S. Cl. CPC F21V 21/22
USPC 362/249.03; 362/249.09

(57) ABSTRACT

A portable, low-energy light tower to provide high, bright light having ground-engaging elements, a telescoping mast secured to the base and the mast having a pivot, the telescoping mast being rotatable about the pivot between a transport position and an operating position, and LED lighting elements at the top end of the telescoping mast. An electrically operated linear actuator mounted on the telescoping mast extends and retracts the telescoping mast through a system of cables and pulleys.

### TECHNICAL FIELD

Light towers.

### BACKGROUND

Safety requirements at oil industry and other work sites require good lighting at night. The lighting elements need to be bright and preferably high so as not to cast too many shadows. Shadows preferably are avoided as much as possible. A solution to having full lighting without shadows is to have many lights, but this adds expense. In addition, the requirements are complicated by the work sites being remote, so that the equipment needs to be easily portable. In addition, it is desirable to have a smaller footprint of the equipment at the work site.

### SUMMARY

There is therefore disclosed a light tower that provides high, bright light from a portable low-energy light tower.

A low-energy light tower is disclosed. In an embodiment, a light tower is provided, comprising a base having ground-engaging elements, a telescoping mast secured to the base, the telescoping mast having a top end, lighting elements at the top end of the telescoping mast; and a linear actuator mounted on the telescoping mast for extending and retracting the telescoping mast, the linear actuator being electrically operated. In an embodiment, the lighting elements are LEDs. In an embodiment, the telescoping mast is rotatable about a pivot to assist movement between a transport position and an operating position.

In various embodiments, there may be included any one or more of the following features: the base has parallel longer sides; the base has a tower cradle, which may be height-adjustable, and the telescoping mast lies on the telescoping tower cradle in the transport position; the telescoping mast, in the transport position, lies at an angle to horizontal; the base has a shape for arranging the light tower in a rectangular grid; the linear actuator is connected to extend and retract the telescoping mast through cables lying along the telescoping mast; the telescoping mast comprises at least four sections; the telescoping mast comprises plural sections, each section having a length of three meters or more; the top end comprises a cross-bar, the cross-bar supporting a pair of panels on either side of the cross-bar; the ground-engaging elements comprise pads; the base comprises fork lift receivers. In a further embodiment, there may be a group of at least three light towers and an electrical generator, each light tower being constructed according to any of the disclosed embodiments, the light towers being electrically connected in a chain to the electrical generator.

These and other aspects of the device are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a perspective view of a light tower with a telescoping mast.

FIG. 2 is a side view of the light tower of FIG. 1 showing a linear actuator and cable system.

FIG. 3 is a perspective view of the light tower of FIG. 1 showing the mast in a transport position.

FIG. 3A is a diagram showing orientation of the mast in a vertical plane for transport.

FIG. 4 is a perspective view of a collection of lights towers of FIG. 1 prepared for transport.

FIG. 5 is an illustration of an employment of light towers of FIG. 1 connected to a power source.

### DETAILED DESCRIPTION

Immaterial modifications may be made to the embodiments described here without departing from what is covered by the claims.

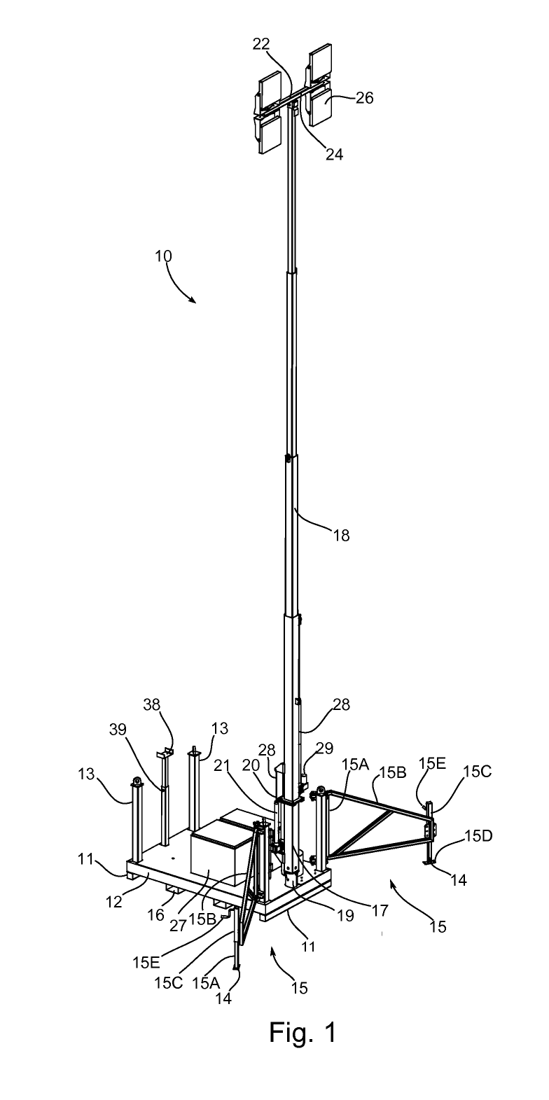

Referring to FIG. 1, a light tower 10 comprises a base 12 having ground-engaging elements 11, 14, and 16. A telescoping mast 18 is supported on the base 12. The mast 18 may have any suitable cross-sectional shape such as round, square, rectangular or other polygonal shape. Ground-engaging elements 14 comprise pads on the end of extendable arms such as swing arms 15. Other extendable arms could be used, for example, sliding arms or arms that are detachable. The ground-engaging elements comprise beams 11 at the respective ends of the base 12. The base may also comprise fork lift receivers 16 for lifting and moving the light tower 10. The fork lift receivers 16 may also function as ground-engaging elements to support the base 12. The swing arms 15 are located at one end of the base 12 and are rotationally attached to the base 12 through posts 15A that extend upward from corners of the base 12. Frames 15B are pivotally mounted on the posts 15A and at the ends of the frames 15B there is a hollow post 15C that receives an extendable bar 15D. The pads 14 are secured to the bottom of the extendable bars 15D. The posts 15A and therefore the pads 14 are preferably height-adjustable, for example, using a rack and pinion system (not shown) operated by a crank 15E. Opposite corners of the base 12 from the posts 15A have posts 13 that extend upward from base 12. The tops of the posts 13 and 15A have eyelets for receiving hooks when the light tower 10 is being hoisted.

The base 12 may include ballast for the light tower 10. Ballast may be provided in any of various ways for weighting the base 12 to resist movement of the mast 18 in winds or when the mast 18 is being telescopically extended. One method of providing ballast for the light tower 10 is to provide weight in the base 12, for example, by making the base 12 out of a steel frame with channels or pockets filled with cement. Another way is to make the light tower 10 and particularly the base 12 out of sufficiently heavy material to resist tipping of the light tower 10. For example, for a 40 ft light tower 10, the light tower 10 may have a weight of about 4000 lbs, most of which is in or near the base 12. The base 12 may itself weigh 11 lbs or more.

A telescoping mast 18 with lower part 17 is secured to the base 12 on cylindrical base 19 and has a pivot 20 at a lower end of the telescoping mast 18. The telescoping mast 18 may be secured to the base 12 in line with the posts 15A. The telescoping mast 18 may be arranged to rotate about a vertical axis extending through the base 19. Handles (not shown) on the lower part 17 of the tower 18 may be used to rotate the mast about the base 19 by hand, although the rotation may also or instead be powered by an electric motor (not shown).

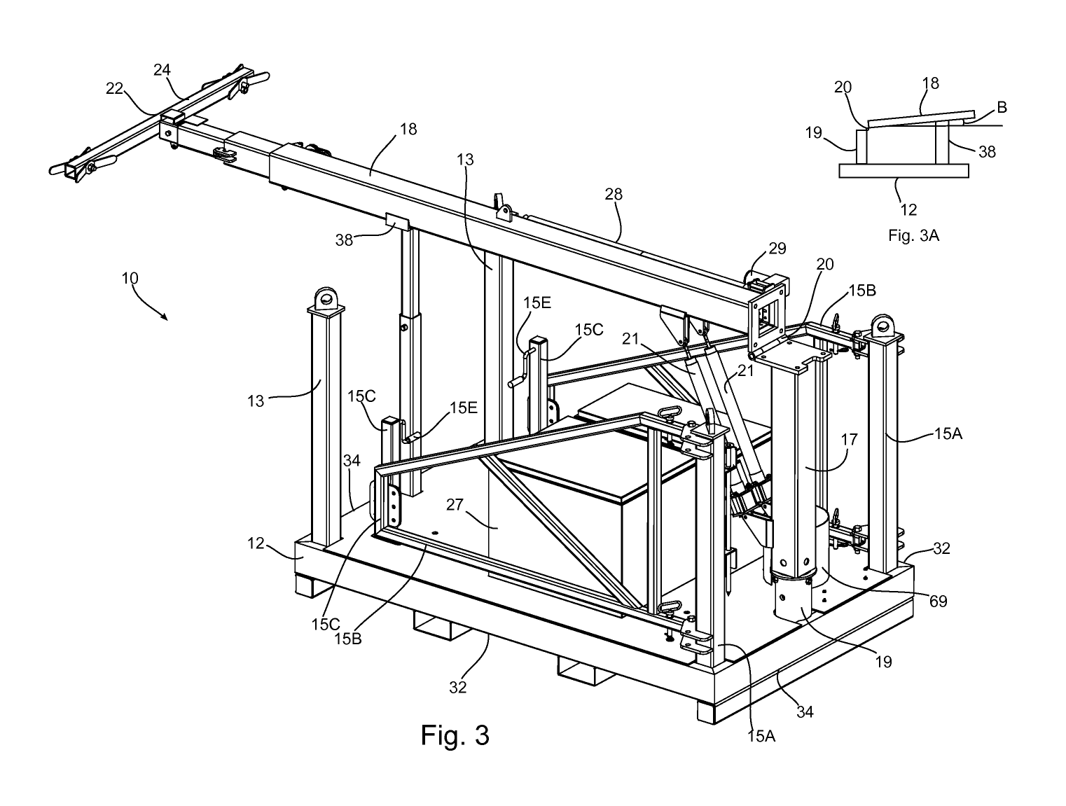

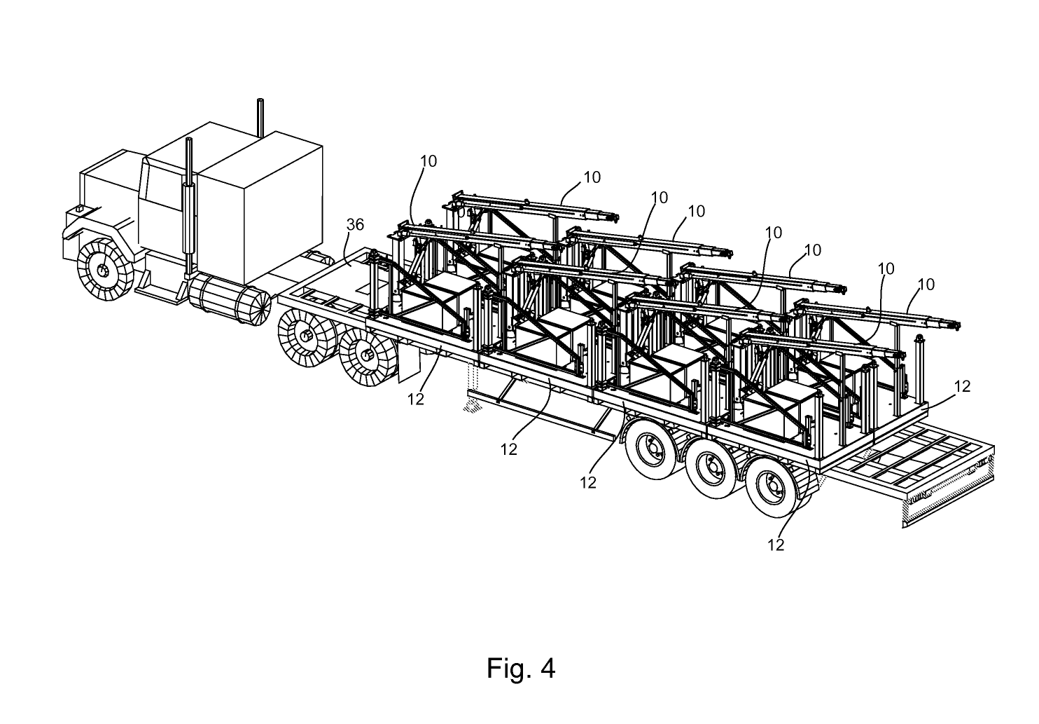

The telescoping mast 18 may also be arranged to rotate about a horizontal axis defined by the pivot 20, using actuators 21, for example, electrical linear actuators. The telescoping mast 18 terminates in a top end 22 formed of a cross-bar 24 on which are mounted lighting elements 26, for example, a pair of LED panels, on either side of the cross-bar. The lighting elements 26 in an embodiment may be LEDs with 19,000 or more lumens per panel. The telescoping mast 18 is rotatable about the pivot 20 between a transport position shown in FIGS. 3 and 4 and an operating position shown in FIG. 1. Boxes 27 on the base 12 may be used to house electrical equipment including LED panels (for example, during transport), backup dry cell batteries, and electrical cables, for example, a cable roll with 60 meter cable. The cross-bar 24 may be arranged to rotate or the LED panels 26 may be arranged to rotate on the cross-bar 24 to allow the panels 26 to point straight down. Another set of LED panels could be oriented to point 180 degrees from the panels 26 shown.

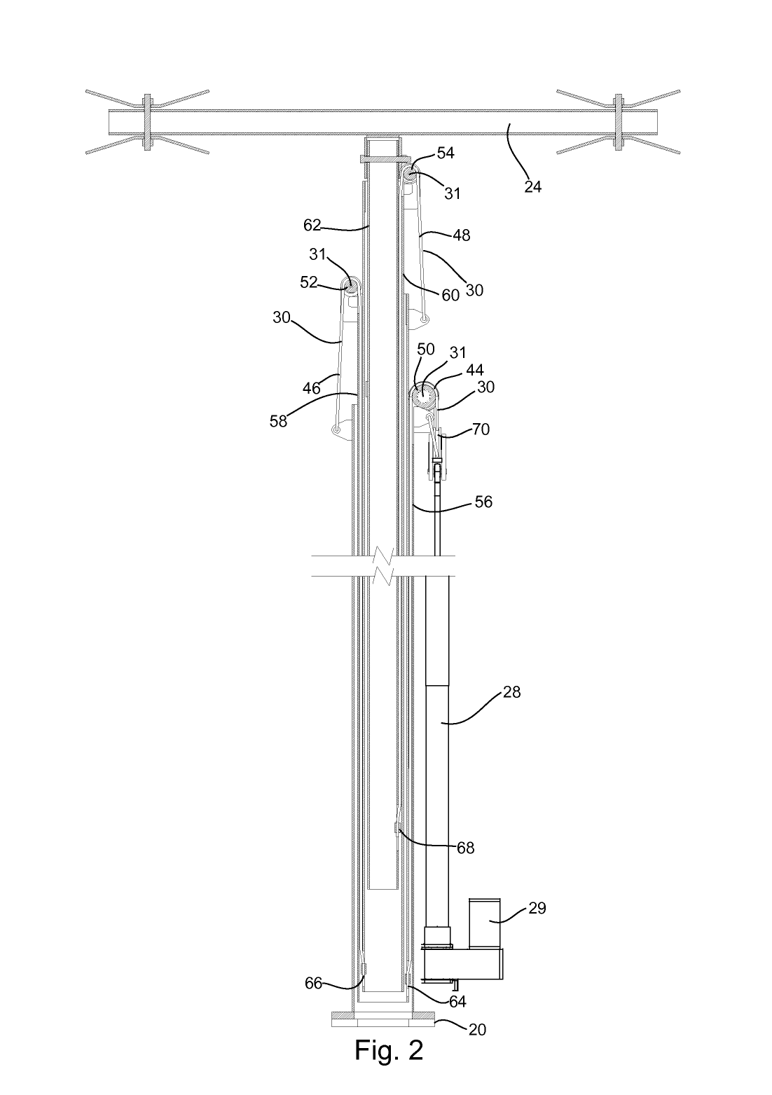

Referring to FIG. 2, a linear actuator 28 is mounted on the telescoping mast 18 for extending and retracting the telescoping mast 18. In conjunction with the actuators 21, the telescoping mast 18 may therefore be first rotated and then extended to move the telescoping mast 18 between the transport position and operating position, and then retracted and rotated back to the transport position when required. The linear actuator 28 is electrically operated and powered by motor 29 through a gear powered nut and screw arrangement (not shown), and is connected to extend and retract the telescoping mast through cables 30 that lie along the telescoping mast 18, although in some embodiments the actuator 28 may be hydraulically or pneumatically operated. Each cable extends around a corresponding pulley 31 attached to the telescoping mast. A first cable also extends around an actuator pulley 70 on the linear actuator 28. The light tower preferably has one less cable than telescoping mast sections. The linear actuator may be any of many suitable commercially available electrical actuators. In some embodiments, if the telescoping mast 18 compacts sufficiently by telescoping, the rotational movement of the telescoping mast 18 may be omitted and only telescoping be used. In such an instance, a larger number of telescoping sections may be used, and the bottom section will be considerably wider than the top section.

An example of a telescoping mast 18 is shown in FIG. 2 with four sections; the cables may be arranged as follows: a first end of the first cable 44 extends over a first pulley 50 mounted close to the top end of a first section 56 of the telescoping mast 18, extends around the actuator pulley 70 attached to the linear actuator 28, and is attached to the outer surface of the first section 56 below the first pulley 50. A second end of the first cable 44 extends between the first section 56 and a second section 58 that extends within the first section 56 and is anchored 64 near the bottom end of the second section 58. A first end of a second cable 46 extends over a second pulley 52 mounted close to the top end of the second section 58 and is attached to the outer surface of the first section 56 near the top of the first section 56. A second end of the second cable 46 extends between the second section 58 and a third section 60 that extends within the second section 58 and is anchored 66 near the bottom end of the third section 60. A first end of a third cable 48 extends over a third pulley 54 mounted close to the top end of the third section 60 and is attached to the outer surface of the second section 58 near the top end of the second section 58. A second end of the third cable 48 extends between the third section 60 and a fourth section 62 that extends within the third section 60 and is anchored 68 near the bottom end of the fourth section 62. This cable and pulley system preferably allows the linear actuator to extend and retract all of the telescoping mast sections simultaneously. Additional cables and pulleys may be added and used to extend and retract additional telescoping sections. The sections of the mast 18 may, for example, be each 3 meters long, for a total of 12 meters height above the pivot 20, which itself may, for example, be 1-2 meters above the base 12. A power cord for the LED lights may be coiled in a cylinder 69 (see FIG. 3) mounted on the base 12 and uncoiled when the LED lights are raised by the actuator 28.

The light tower 10 is preferably designed to fit together with other light towers 10 of the same shape to form a rectangular grid for transport, as shown in FIGS. 3, 3A, and 4. In an embodiment, the base 12 has parallel longer sides 32 and shorter sides 34. In the transport position as shown in FIGS. 3 and 3A, the telescoping mast 18 lies at an angle B above horizontal supported by telescoping tower cradle 38. A pin 39 (see FIG. 1) on the telescoping tower cradle 38 may be inserted in corresponding holes in the outer and inner members of the cradle 38 to adjust the angle B. The angle B is chosen so that telescoping masts 18 of adjacent light towers 10 do not interfere with each other even when loaded for transport on a vehicle 36 with the telescoping masts 18 in the retracted position, with the top ends 22 extending beyond the foot print of the bases 12. The mast 18 may also be lowered, for example, to or below horizontal on the cradle 38, for ease of working on the LEDs and other components on the mast 18. For example, the lighting elements are preferably detached from the top of the mast 18 for transport. As shown in FIG. 4, the bases 12 are suitably shaped to fit together in a rectangular grid, for example, by being rectangular or other space filling polygonal shape.

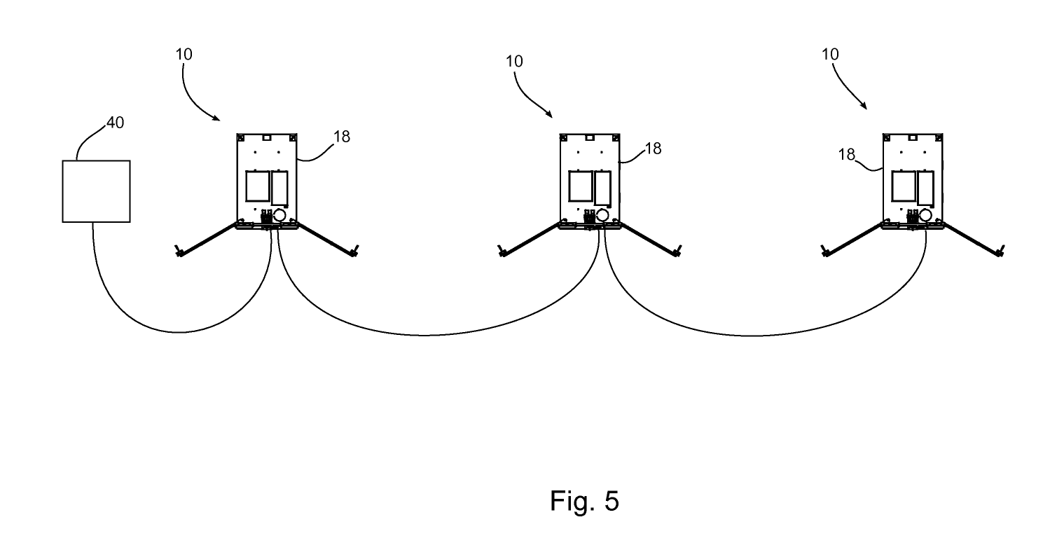

The telescoping mast 18 preferably comprises at least four sections of length three meters or more. As shown in FIG. 5, with a group of light towers 10 deployed at a work site with the telescoping masts 18 in operating upright position, the light towers 10 may be organized in an electrically connected chain of three (or more) light towers 10 and connected to a single electrical generator 40. Additional light towers 10 may be added as the capacity of the electrical generator 40 permits. The light tower may be powered from an onsite AC generator with battery backup. The AC generator may be disconnected and the light tower run on battery backup when maintenance is being done on the AC generator. In an embodiment, the battery backup may supply 3 hours of battery reserve at 40 amps and 24 volts. A photocell may be used in the electrical circuit to shut down power during daylight hours when lights are not required.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A light tower, comprising:
a base having ground-engaging elements;
a telescoping mast secured to the base, the telescoping mast having a top end;
LED lighting elements at the top end of the telescoping mast; and
a linear actuator mounted on the telescoping mast for extending and retracting the telescoping mast, the linear actuator being electrically operated.

2. The light tower of claim 1 in which the telescoping mast has a pivot and is rotatable about the pivot for movement, in conjunction with operation of the linear actuator, of the telescoping mast between a transport position and an operating position.

3. The light tower of claim 2 in which the base has a tower cradle for receiving the telescoping mast in the transport position.

4. The light tower of claim 3 in which the tower cradle is height-adjustable and, in the transport position, the telescoping mast lies at an angle to horizontal.

5. The light tower of claim 1 in which the base has a shape for arranging the light tower in a rectangular grid.

6. The light tower of claim 1 in which the linear actuator is connected to extend and retract the telescoping mast through cables lying along the telescoping mast.

7. The light tower of claim 1 in which the telescoping mast comprises at least four sections.

8. The light tower of claim 1 in which the telescoping mast comprises plural sections, each section having a length of three meters or more.

9. The light tower of claim 1 in which the top end comprises a cross-bar, the cross-bar supporting a pair of panels on either side of the cross-bar, the panels supporting the lighting elements.

10. The light tower of claim 1 in which the ground-engaging elements comprise pads at the ends of extendable arms, the extendable arms being mounted on the base.

11. The light tower of claim 10 in which the base comprises fork lift receivers.

12. A light tower, comprising:
a base having ground-engaging elements;
a telescoping mast secured to the base, the telescoping mast having a top end;
lighting elements at the top end of the telescoping mast;
an actuator mounted on the telescoping mast for extending and retracting the telescoping mast;
the telescoping mast having a pivot and being rotatable about the pivot for movement, in conjunction with operation of the linear actuator, of the telescoping mast between a transport position and an operating position; and
the base having a tower cradle for receiving the telescoping mast in the transport position.

13. The light tower of claim 12 in which the tower cradle is height-adjustable and, in the transport position, the telescoping mast lies at an angle to horizontal.

14. The light tower of claim 12 in which the base has a shape for arranging the light tower in a rectangular grid.

15. The light tower of claim 12 in which the lighting elements are LEDs.

16. A light tower, comprising:
a base having ground-engaging elements;
a telescoping mast secured to the base, the telescoping mast having a top end;
lighting elements at the top end of the telescoping mast;
an actuator mounted on the telescoping mast for extending and retracting the telescoping mast; and
the ground-engaging elements comprising pads at the ends of extendable arms, the extendable arms being mounted on the base.

17. The light tower of claim 16 in which the extendable arms comprise swing arms.

18. The light tower of claim 16 in which the base comprises fork lift receivers.

19. The light tower of claims 16 in which the pads are height-adjustable.

20. The light tower of claim 16 in which the lighting elements are LEDs.
